(19) United States
(12) Patent Application Publication
(10) Pub. No.: US 2018/0290715 A1
(43) Pub. Date: Oct. 11, 2018

(54) STRUCTURAL WATERPROOF FILM AND USES THEREOF

(71) Applicant: Paul BARRON, Papamoa (NZ)

(72) Inventor: Paul BARRON, Papamoa (NZ)

(21) Appl. No.: 15/766,768

(22) PCT Filed: Oct. 18, 2016
(86) PCT No.: PCT/NZ2016/050170

§ 371 Date: Apr. 6, 2018

(30) Foreign Application Priority Data
Oct. 18, 2015 (NZ) 712469

(51) Int. Cl. B63B 5/24; B63B 35/79

(52) U.S. Cl. CPC B63B 5/24; B32B 5/245; B63B 35/7909

(57) ABSTRACT

Described herein are structural waterproof films comprising a composite of at least one wool sheet, the wool sheet being at least partially impregnated with a hardening resin that, when hardened, is rigid or semi-rigid and is substantially water impermeable. The films described introduce organic materials into, among many applications, water craft design plus the films described offer a useful alternative to traditional non-organic fibreglass construction.

### TECHNICAL FIELD

Described herein is a structural waterproof film and uses thereof. The film may use wool impregnated with a resin that is moulded to form a film. The film may be moulded onto a substrate. The film may be used to manufacture watercraft devices such as surfboards or kayaks or boat parts.

### BACKGROUND ART

Watercraft devices such as surfboards and kayaks have been made more many years, the design of the board or kayak gradually altering as new materials and techniques become available.

US publication number 2010/0240271 provides detailed synopsis of the history of surfboard manufacture and in the interests of brevity, this publication is referred to and incorporated herein.

To summarise, surfboards are traditionally manufactured from a blank comprising two polyurethane (PU) foam sections and a wooden or foam ‘stringer’ extending from the nose of the board to the tail which gives structure to the board. PU foam alone lacks the structural integrity required as it is bendy up to a point and then fails dramatically. A stringer is traditionally added in order to reduce the board flex and thereby minimise board breakage and improve board performance. Stringer designs typically represent the best compromise between strength and board dynamics. The board then includes a layer of fibreglass and resin over the foam and stringer to give water resistance and structural strength yet still enough flex to allow for the desired board dynamics.ve using fibreglass and resin mixtures may be used in a variety of other watercraft, examples including kayaks, kite boards, windsurfer boards, paddle boards, canoes. Fibreglass and resin mixtures may also be widely used in boat manufacture to form a hull or parts of a hull or to form seats, walls and other structures on boats. Reference above to surfboards should therefore not be seen as limiting.

Fibreglass whilst giving some useful strength is not ideal. It is a man made material that is not from a sustainable source. There are also many safety considerations to its use. For example, the International Agency for Research on Cancer (IARC) has classified all synthetic mineral fibres (SMF) as being possibly carcinogenic to humans. Some literature disputes this criteria but the findings on this point are not conclusive. In any case special precautions are described under health and safety law at least in New Zealand to avoid irritation of the eyes, nose, skin and respiratory tract associated with handling fibreglass.

Furthermore, there is a consumer trend to move away from synthetic materials and to utilise more natural sources of materials. The trend arises from a greater awareness of the environment and the need to minimise the impact of consumer goods both from a manufacturing viewpoint and from the viewpoint of disposal. Synthetically produced materials may often require special processing to manufacture and, for example with plastics, do not readily breakdown once disposed of leaving a lingering environmental impact.

It may be advantageous for example to replace synthetic materials in watercraft devices with natural alternatives or at least to provide the public with a choice.

Further aspects and advantages of the films and uses thereof will become apparent from the ensuing description that is given by way of example only.

### SUMMARY

Described herein are structural waterproof films comprising a composite of at least one wool sheet, the wool sheet being at least partially impregnated with a hardening resin that, when hardened, is rigid or semi-rigid and is substantially water impermeable. The films described introduce organic materials into, among many applications, water craft design plus the films described offer a useful alternative to traditional non-organic fibreglass construction.

In a first aspect, there is provided a structural waterproof film comprising a composite of at least one wool sheet, the wool sheet being at least partially impregnated with a hardening resin that, when hardened, is rigid or semi-rigid and is substantially water impermeable.

In a second aspect, there is provided a watercraft device or part thereof with at least one outer coating layer comprising a composite of at least one wool sheet at least partially impregnated with a hardening resin that, when hardened, provides a substantially water impermeable layer over all or part of the internal structure of the watercraft device or part thereof and which provides structural strength to the device exterior or part thereof.

In a third aspect, there is provided a method of a producing a structural waterproof film comprising a composite of at least one wool sheet at least partially impregnated with a hardening resin, the method comprising:
(a) selecting at least one wool sheet;
(b) at least partially impregnating the at least one wool sheet with the hardening resin;
(c) allowing or causing the resin to harden to form the structural waterproof film.

In a fourth aspect, there is provided a method of a producing a watercraft device or part thereof with at least one outer coating layer comprising a composite of at least one wool sheet at least partially impregnated with a hardening resin, the method comprising:
(a) selecting a substrate on which the outer coating layer is to be applied;
(b) selecting at least one wool sheet;
(c) at least partially impregnating the at least one wool sheet with hardening resin;
(d) applying the at least one resin impregnated wool sheet to at least part of the substrate to form a first outer coating layer on the substrate;
(e) optionally, repeating steps (b) to (d) to add at least one further outer coating layer to the substrate; and
(f) allowing the at least one outer layer to harden.

Advantages of the above films and uses thereof will become apparent including replacement of a non-natural fibre (fibre glass) with a more environmentally acceptable fibre (wool) and the improved strength and dynamics that the inventor has unexpectedly identified from the new design.

### BRIEF DESCRIPTION OF THE DRAWINGS

Further aspects of the watercraft device will become apparent from the following description that is given by way of example only and with reference to the accompanying drawings in which:

FIG. 1 illustrates a cross section sketch of a traditional surfboard configuration;

FIG. 2 illustrates a cross section sketch of an embodiment of a surfboard configuration incorporating wool;

FIG. 3 is a photograph of a wool layer fixed to a foam layer with a pen included to provide an indication as to the relative size of the layer; ad

FIG. 4 illustrates a sketch showing the way the outer layer may be used in the design of a kayak or canoe.

### DETAILED DESCRIPTION

As noted above, described herein are structural waterproof films comprising a composite of at least one wool sheet, the wool sheet being at least partially impregnated with a hardening resin that, when hardened, is rigid or semi-rigid and is substantially water impermeable. The films described introduce organic materials into, among many applications, water craft design plus the films described offer a useful alternative to traditional non-organic fibreglass construction.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

For the purpose of this specification the term ‘comprise’ and grammatical variations thereof shall have an inclusive meaning—i.e. that it will be taken to mean an inclusion of not only the listed components it directly references, but also other non-specified components or elements.

The term ‘watercraft device’ or grammatical variations thereof refers to a structure or device that is capable of floating. In certain embodiments, the floatation device is an aquatic sports board such as a surfboard, windsurf board, stand up paddle board, wake board, knee board, body board, kite board, paddle board, kayak, canoe or the like.

The term ‘surfboard’ or grammatical variations thereof incorporates short boards, long boards, gun surfboards, fish surfboards, egg surfboards and the like and boards ranging in length from less than 4 feet long to greater than 13 feet long.

The term ‘blank’ or grammatical variations thereof refer to the internal structure of a floatation device or board that forms the basic structure and shape of the device or board. In surfing terms, the blank is the internal foam structure with the outer layer of for example fibreglass or wool as used in this specification removed. The blank is the part of the board that is shaped to the desired contours and gives the board an overall shape.

The term ‘fibreglass’ or grammatical variations thereof refer to a matrix fine fibres of glass, typically in the form of a woven sheet but may also encompass spheres or chopped fibres (non-woven).

The term ‘wool’ or grammatical variations thereof refers to the textile fibre derived from sheep and certain other animals including cashmere or mohair from goats and other types of wool from animals such as rabbits, and wools derived from camelids.

The term ‘length’ or grammatical variations thereof as used when described the watercraft device or related products such as surfboards refers to the distance between the device nose and tail.

The term ‘width’ or grammatical variations thereof as used when described the floatation device or related products such as surfboards refers to the distance between each rail or side of the board or device, generally as measured about the centre of the board length or at the device or board's widest width.

The term ‘height’ or ‘depth’ or grammatical variations thereof may be used interchangeably as used when described the floatation device or related products such as surfboards refers to the distance between the device deck or top and the device base of underside, generally as measured about the centre of the board length or at the device or board's greatest height/depth.

The term ‘board dynamics’ and/or ‘watercraft dynamics’ refers collectively to the way the board or watercraft device reacts when ridden and incorporates actions such as strength, rigidity and flex.

The term ‘waterproof’ or ‘water impermeable’ as used herein refers to the formed film or layer(s) have a water permeability of approximately zero.

The term ‘structural’ as used herein when referring to the structural film refers to a rigidity and material strength equivalent or better than traditional fibreglass and resin combinations.

In a first aspect, there is provided a structural waterproof film comprising a composite of at least one wool sheet, the wool sheet being at least partially impregnated with a hardening resin that, when hardened, is rigid or semi-rigid and is substantially water impermeable.

The at least one wool sheet may be a non-woven matrix of wool fibres. Alternatively, the at least one wool sheet may be manufactured from a combination of woven and non-woven wool fibres, either in or not in a matrix. Further, the at least one wool sheet may be manufactured from woven wool fibres, either in or not in a matrix. In the inventor's experience, a non-woven matrix appears to offer the optimum compromise between material cost and final properties however, as noted above, other wool forms may be used.

The at least one wool sheet may be fully impregnated with resin. As noted above, partial impregnation may be within the scope however, full impregnation may be useful to maximise structural properties for the film or watercraft. Non-impregnated regions may be weaker and/or cause localised stresses. This point noted, achieving full impregnation is challenging as

The outer coating layer may be 0.01, 0.05, or 0.075, or 0.1, or 0.5, or 1, or 1.5, or 2, or 2.5, or 3, or 3.5, or 4, or 4.5, or 5 mm thick. In one embodiment, the thickness or the outer layer may be 1-2 mm. The wool sheet may be 0.01, 0.05, or 0.075, or 0.1, or 0.5, or 1, or 1.5, or 2, or 2.5, or 3, or 3.5, or 4, or 4.5, or 5 mm thick. In one embodiment the wool sheet may be 1-2 mm thick. As demonstrated here, the wool sheet may comprise the majority of the outer layer or layers width and the resin content minimised.

The wool sheet may have a density of approximately 100-500 gm of fibres/m². In one embodiment the density may be 100-200 gm of fibres/m². The inventor has found that the wool may be a lower grade quality therefore reducing raw material costs.

The hardening resin may be a resin. The hardening resin may be an epoxy resin. The hardening resin may be a thermosetting polymer.

In a second aspect, there is provided a watercraft device or part thereof with at least one outer coating layer comprising a composite of at least one wool sheet at least partially impregnated with a hardening resin that, when hardened, provides a substantially water impermeable layer over all or part of the internal structure of the watercraft device or part thereof and which provides structural strength to the device exterior or part thereof.

The watercraft device may be selected from the group consisting of: a surfboard, a stand-up paddle (SUP) board, a windsurfing board, a kite board, a wake board, a kneeboard, a kayak, and a canoe. The watercraft device may be at least one boat part.

Reference is made above to internal structure of the watercraft. The internal structure may be a substrate on which the outer layer is placed which then becomes integral to the final product. By way of example, this may be a foam or stringer or plastic on which the outer layer is placed. Alternatively, the term internal structure refers to the interior of the watercraft such as the hollowed interior of a kayak where the user sits. In this embodiment, the outer layer may be placed on a substrate and the substrate may or may not form part of the final watercraft structure. For example, the outer layer of a kayak may be formed as above on a mould substrate and, once the outer layer hardens, the substrate may be removed revealing a wool fibre and resin composite itself that forms the kayak wall.

The at least one outer layer may fully enclose the watercraft device internal feature or features.

The at least one outer coating layer may be applied to, and adhere to, a foam material.

The foam material may be closed cell foam. In this embodiment, the gas pockets in the foam are sealed up from each other so that the foam cannot soak up water. The foam may have a low density. In one embodiment, the foam may be manufactured from polystyrene, polyurethane (PU) and combinations thereof. The foam may be expanded polystyrene (EPS). EPS and PU foams are known and used in watercraft manufacture and it is the inventor's experience that they are compatible with the wool sheet and resin mixture and a strong bond forms between the foam and outer layer. A foam may be important to achieve the desired level of flotation for example as used in surfboards. In a kayak or canoe, foam may not be used although a foam layer in part or all of the kayak or canoe wall(s) may be helpful to reduce the overall device weight and improve rigidity and strength.

The hardening resin may be a thermosetting polymer. The hardening resin may be an epoxy resin. Other alternative resins may also be used such as vinyl-ester or polyester thermosetting plastic or phenol formaldehyde resins. Epoxy resin is anticipated to be a useful choice as it is well known and used in the watercraft industry and in the inventor's experience, gives good results in the formation of various devices with the wool sheets described herein.

The outer layer may also include other compounds. By way of example, the outer layer resin may include a colouring agent, which then allows the manufacturer to colour all or part of the outer layer.

The watercraft device may include a fin or fins integral to the blank or outer layer. Alternatively, the floatation device may instead include apertures in the blank or outer layer to fit fin systems such as FCS fins.

In a third aspect, there is provided a method of a producing a structural waterproof film comprising a composite of at least one wool sheet at least partially impregnated with a hardening resin, the method comprising:
(a) selecting at least one wool sheet;
(b) at least partially impregnating the at least one wool sheet with the hardening resin;
(c) allowing or causing the resin to harden to form the structural waterproof film.

Steps (a) to (c) above may be repeated to add additional outer coating layers.

In a fourth aspect, there is provided a method of a producing a watercraft device or part thereof with at least one outer coating layer comprising a composite of at least one wool sheet at least partially impregnated with a hardening resin, the method comprising:
(a) selecting a substrate on which the outer coating layer is to be applied;
(b) selecting at least one wool sheet;
(c) at least partially impregnating the at least one wool sheet with hardening resin;
(d) applying the at least one resin impregnated wool sheet to at least part of the substrate to form a first outer coating layer on the substrate;
(e) optionally, repeating steps (b) to (d) to add at least one further outer coating layer to the substrate; and
(f) allowing the at least one outer layer to harden.

The watercraft device above may be selected from the group consisting of: a surf board, a stand-up paddle (SUP) board, a windsurfing board, a kite board, a wake board, a knee board, a kayak, a canoe. In these embodiments, the substrate may be closed cell foam.

Alternatively, the watercraft device in the above method may be a boat part or parts.

The at least one wool sheet and resin mixture in the above methods may be forced together to cause resin impregnation of the at least one wool sheet. Forcing together may for example be achieved through increased pressure. Forcing together may be achieved through use of a vacuum.

During step (f), the at least one outer coating layer and substrate may be subjected to pressure or vacuum to force the at least one outer layer onto the substrate during hardening.

Forcing together (by pressure or vacuum) may be completed to remove excess resin from the wool sheet to assist with hardening (too much resin results in a slower hardening process. Too much resin may also impair the final product finish and is simply messy to handle. One method of forcing together may be by passing the resin and wool sheet mixture through a press or roller. It should be noted that wool does not easily mix with resin, the wool tending to repel the resin. This is why a forcing together step is helpful depending on the degree of impregnation desired. The repellent effects of wool tend to lead away from use of this material as a natural assumption is that (a) the wool would not be easy to use in watercraft manufacture and (b) the wool might impair the final product performance. The inventor found unexpectedly that although some care was needed to achieve impregnation, this was not onerous and the end results were very good if not superior in some respects to traditional fibreglass designs.

During step (f), the outer coating layer or layers and substrate may be subjected to pressure or vacuum to force the outer layer or layers onto the substrate during hardening. A simple method of achieving the above pressure/vacuum may be to enclose the outer layer(s) and substrate in a bag and evacuate the bag so as to force the bag walls against the outer layer(s) and squeeze the parts together. After hardening is complete, the bag may be removed. In one embodiment, the bag internal surface may be smooth to achieve a smooth outer layer surface or the bag may have surface features that in turn pass into the outer layer(s) transferring the surfaces feature(s) to the outer layer(s). A liner may also be used between the bag and outer layer to influence the surface finish. Pressure or vacuum may be achieved through other methods such as moulds or chambers and the example of a bag should not be seen as limiting.

The hardening time in step (f) may be dependent on various factors such as the resin chosen, outer layer thickness, ambient temperature, wool grade and density, but in the inventor's experience 6-12 hours may be sufficient time to achieve full hardening at 20-30° C.

Advantages of the above should be apparent including the integration of a naturally derived and sustainable raw material source (wool) that is more acceptable environmentally and from a handling perspective to fibreglass. The wool may be a lower cost grade or even waste material hence minimising raw material expense. The final product is lightweight—at least comparable with or lighter than equivalent fibreglass boards. The final product is unexpectedly strong. The inventor tested the impact strength of a double layer surfboard deck (two wool sheets of 150 gm/m2) by attempting to break a hole in the board with a hammer. Despite several attempts, no impression was left in the board. The equivalent fibreglass board would suffer considerable damage from the same test. A further advantage given the high strength may be the ability to reduce the amount of fibre used compared to the equivalent fibreglass board and thereby reduce the cost of manufacture. Another aspect important in watercraft design is that the outer layer still has sufficient flex to allow for the desired board dynamics. In tests completed by the inventor, the board easily accomplishes the desired aims in terms of feel and flexibility. Finally, it is the inventor's expectation that the layers will not delaminate since the materials appear to be highly compatible with each other.

The embodiments described above may also be said broadly to consist in the parts, elements and features referred to or indicated in the specification of the application, individually or collectively, and any or all combinations of any two or more said parts, elements or features, and where specific integers are mentioned herein which have known equivalents in the art to which the embodiments relates, such known equivalents are deemed to be incorporated herein as of individually set forth,

Where specific integers are mentioned herein which have known equivalents in the art to which this invention relates, such known equivalents are deemed to be incorporated herein as if individually set forth.

### WORKING EXAMPLES

The above films and uses thereof are now described by reference to specific examples. Reference is made to the device being a surfboard however this should not be seen as limiting as it should be appreciated that other types of aquatic boards or watercraft may also be manufactured using similar design techniques.

### Example 1

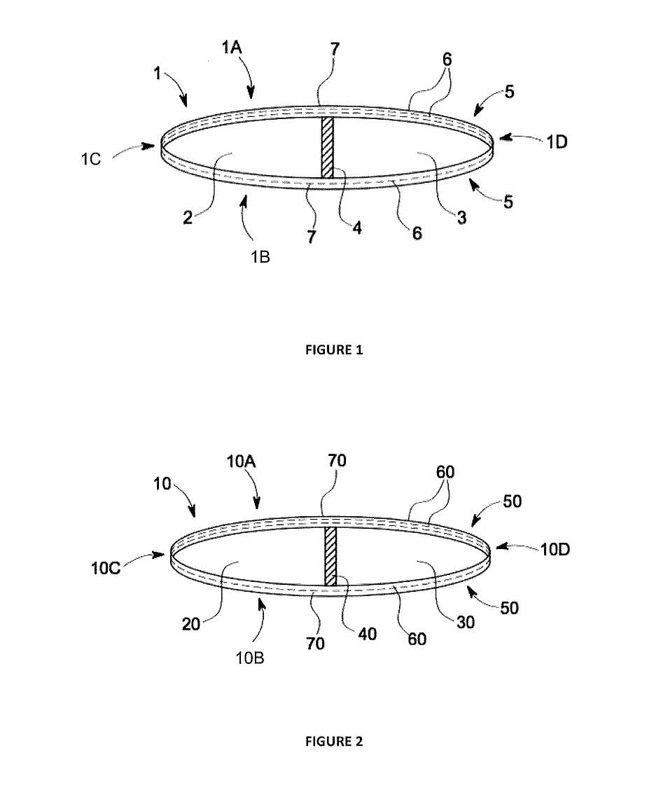

Referring to FIG. 1, a cross section of an art surfboard 1 is illustrated with a top 1A, bottom 18 and sides 1C and 1D. The board 1 comprises a so-called ‘blank’ portion that includes two foam sides 2, 3 made from polyurethane (PU) foam and a stringer 4 typically made from a lightweight wood such as balsa wood. To produce a finished surfboard 1, the stringer 4 and foam sides 2, 3 are covered in an outer layer generally indicated by line 5. The layer 5 includes a mixture of one or more sheets of fibreglass 6, typically more on the top or deck 1A of the board 1 than bottom 18 of the board 1 for structural reasons. The fibreglass sheet or sheets 6 are mixed with a hardening resin 7 that sets and the fibreglass 6 is held within the resin 7. The art board 1 design described has been used for many years as, while it is far from perfect, it represents a useful compromise between weight and ease of manufacture, cost and strength. The design has also stayed this way for many years owing to a degree of inertia in the industry to change, boards shapes and designs being secretive and traditional.

### Example 2

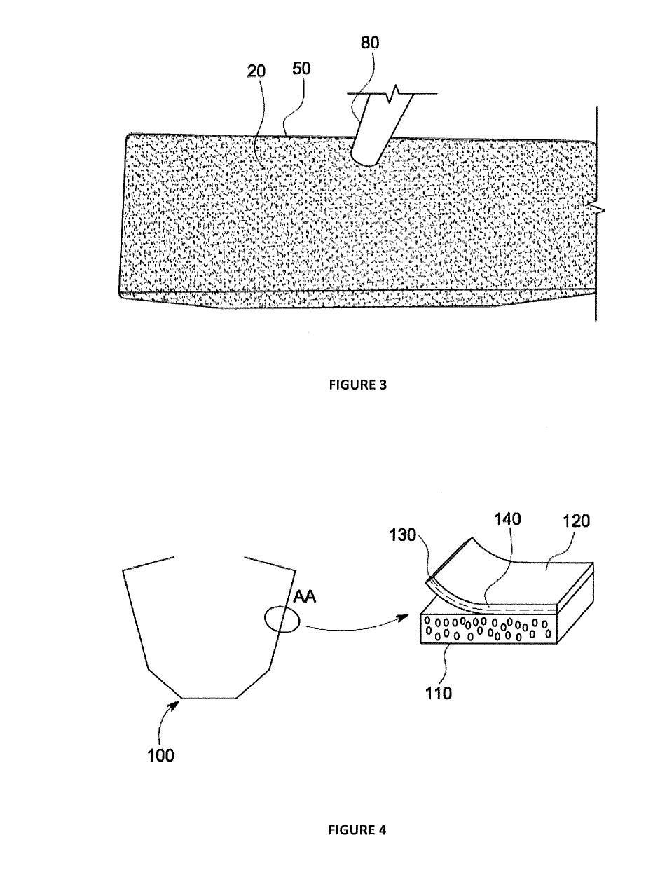

FIGS. 2 and 3 illustrate a first embodiment of a surfboard 10 based on the new design described herein, generally indicated by arrow 10.

FIG. 2 shows a cross-section of a board 10 using wool sheets 60 in the resin 70. As shown, the internal features of the board 10 blank can remain the same as art designs with a stringer 40 and foam sides 2, 3 and the basic layering principle in the wool embodiment also remains similar—that is the wool layers 60 remain in a similar placement as the fibreglass layers 6 shown in FIG. 1. Multiple wool layers 60 may be added, generally to the deck 10A region for strength although it is possible to also add multiple layers to the underside 108 as well. In the inventor's experience, it is sufficient to use a single layer 60 on the bottom 108 and a dual (two) layer 60 structure on the top or deck 10A of the board 10.

An outer layer 50 may be used to give a smooth finish, to seal the board 10 blank structure and to strengthen the board 10.

The complete board 10 may include a fin or fins (not shown) integral to the board 10 or instead, the complete board may instead include apertures in the board 10 or outer layer (not shown) to fit fin systems such as FCS fins.

FIG. 3 shows a sample of EPS foam 20 with an outer layer 50 adhered on. A pen 80 is included in the image for scale. As shown, the outer layer may be only 0.5 to 5 mm thick or 1-2 mm thick.

### Example 3

Referring to FIG. 4, a second embodiment is illustrated, in this example showing the outer layer 120 with a wool sheet 140 as used in a kayak 100 design. Detail AA shows a close up of a potential kayak wall design. Use of fibreglass and resin mixtures in kayaks or canoes is relatively unusual since this combination does not have the strength desired in these products. Kayaks and canoes range widely in the materials used, the more robust designs being made from plastics while the more lightweight and high-end designs may be made from fibreglass or even carbon fibre. The compromise is a trade off between weight and strength—sea kayaks for example require considerable strength and hence are made from plastic and are heavy. Racing kayaks and skis are narrow and lightweight and hence fibreglass or carbon fibre are acceptable materials to use, strength be of less concern. As may be appreciated, the above described wool sheet and resin layer may be used as an alternative to fibreglass and/or carbon materials in kayaks and canoes. Based on the inventor's findings to date, the high strength achieved from the wool may even offer greater strength and other characteristics over existing materials and designs whilst offering a more environmentally acceptable alternative. Whilst perhaps not being essential, a foam layer such as that illustrated in FIG. 4 by item 110 may also be integrated into the kayak wall offering greater stiffness and some in-built flotation compared to purely fibreglass walls that offer no flotation. A kayak made from the above described wool and resin approach may also reduce the weight of kayaks since less material is needed to achieve the desired level of strength. The foam and wool/resin layer may also be advantageous, as it will have a greater degree of insulation from cold and noise as well compared to art designs.

As noted above, in the embodiments described and illustrated, reference may made to the watercraft device being a surfboard or board. The design described may also be used for other aquatic board sports such as for stand-up paddle (SUP) boards, windsurfing boards, kite boards, wake boards, body boards, kayaks, canoes and so on.

Aspects of the films and uses thereof have been described by way of example only and it should be appreciated that modifications and additions may be made thereto without departing from the scope of the claims herein.

What is claimed is:

1. A structural waterproof film system comprising:
a structural waterproof film that comprises a composite of at least one wool sheet,
wherein the at least one wool sheet is at least partially impregnated with a hardening resin,
wherein when the hardening resin is hardened, is rigid or semi-rigid, the at least one wool sheet is substantially water impermeable.

2. The structural waterproof film system as claimed in claim 1 wherein the at least one wool sheet is a non-woven matrix of wool fibres.

3. The structural waterproof film system as claimed in claim 1 wherein the at least one wool sheet is fully impregnated with the hardening resin.

4. The structural waterproof film system as claimed in claim 1 wherein the structural waterproof film is 0.01 to 5 mm thick;
wherein a wool sheet of the at least one wool sheet is 0.01 to 5 mm thick and has a density of approximately 100-S00 gm of fibres/m².

5. (canceled)

6. (canceled)

7. The structural waterproof film system as claimed in claim 1 wherein the hardening resin is a thermosetting polymer or an epoxy resin.

8. (canceled)

9. The structural waterproof film system as claimed in claim 1 further comprising:
a watercraft device or part thereof wherein said watercraft device or part thereof comprises an internal structure and a watercraft device exterior wherein said watercraft device is configured with an outer coating layer or layers comprising said structural waterproof film over all or part of the internal structure of the watercraft device and which provides structural strength to the watercraft device exterior or part thereof.

10. The structural waterproof film system as claimed in claim 9 wherein the watercraft device is selected from the group consisting of: a surf board, a stand-up paddle (SUP) board, a windsurfing board, a kite board, a wake board, a knee board, a kayak, a canoe.

11. The structural waterproof film system as claimed in claim 9 wherein the watercraft device or part thereof comprises at least one boat part.

12. (canceled)

13. The structural waterproof film system as claimed in claim 9 wherein the at least one outer coating layer is coupled with, and adheres to, a foam material.

14. The structural waterproof film system as claimed in claim 13 wherein the foam material is a closed cell foam.

15. The structural waterproof film system as claimed in claim 13 wherein the foam material comprises polystyrene, or polyurethane or any combination thereof.

16. A method of a producing a structural waterproof film comprising a composite of at least one wool sheet, the method comprising:
selecting the at least one wool sheet;
at least partially impregnating the at least one wool sheet with the hardening resin to form at least one resin impregnated wool sheet; and,
allowing or causing the resin to harden to form the structural waterproof film.

17. The method of producing a structural waterproof film as claimed in claim 16 wherein the method is repeated to add additional outer coating layers to the structural waterproof film.

18. The method of producing a structural waterproof film as claimed in claim 16 wherein a watercraft device or part thereof comprising an internal structure and a watercraft device exterior is created by the method comprising:
selecting a substrate on which the at least one outer coating layer is to be applied;
applying the at least one resin impregnated wool sheet to at least part of the substrate to form a first outer coating layer on the substrate;
optionally repeating
said selecting said at least one wool sheet and
said at least partially impregnating the at least one wool sheet with hardening resin and
said applying applying the at least one resin impregnated wool sheet to at least part of the substrate to form a first outer coating layer on the substrate,
to add at least one further outer coating layer to the substrate.

19. The method as claimed in claim 18 wherein the watercraft device is selected from the group consisting of: a surf board, a stand-up paddle (SUP) board, a windsurfing board, a kite board, a wake board, a knee board, a kayak, a canoe.

20. The method as claimed in claim 19 wherein the substrate is a closed cell foam.

21. The method as claimed in claim 18 wherein the watercraft device or part thereof comprises at least one boat part.

22. The method as claimed in claim 16 further comprising forcing the at least one wool sheet and the hardening resin together to cause resin impregnation of the at least one wool sheet.

23. The method as claimed in claim 22 wherein the forcing is achieved through increased pressure or use of a vacuum.

24. (canceled)

25. The method as claimed in claim 18 further
subjecting the at least one outer coating layer and watercraft device or part thereof to a pressure or a vacuum to force the at least one outer layer onto the watercraft device or part thereof during hardening.
